(19) United States
(12) Patent Application Publication
(10) Pub. No.: US 2026/0029942 A1
(43) Pub. Date: Jan. 29, 2026

(54) COUNTER FOR REFRESHING TRANSIENT STATE OF MEMORY BLOCK

(71) Applicant: Micron Technology, Inc., Boise, ID (US)

(72) Inventors: Giuseppe Cariello, Boise, ID (US); Jonathan Scott Parry, Boise, ID (US)

(21) Appl. No.: 19/265,858

(22) Filed: Jul. 10, 2025

Related U.S. Application Data
(60) Provisional application No. 63/676,811, filed on Jul. 29, 2024.

(51) Int. Cl. G06F 3/06

(52) U.S. Cl. CPC G06F 3/064; G06F 3/0604; G06F 3/0679

(57) ABSTRACT

Various embodiments described herein provide for using one or more counters for refreshing a transient state of one or more memory blocks of a memory device (e.g., a NAND-type memory device, such as a 3D NAND-type memory device) of a memory system.

### PRIORITY APPLICATION

This application claims the benefit of priority to U.S. Provisional Application Ser. No. 63/676,811, filed Jul. 29, 2024, which is incorporated herein by reference in its entirety.

### TECHNICAL FIELD

Embodiments of the disclosure relate generally to memory systems and, more specifically, to using a counter for refreshing a transient state of a block of a memory device of a memory system, such as a memory sub-system, which can facilitate improved readability of data stored in the memory block.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 is a block diagram illustrating an example computing system that includes a memory sub-system, in accordance with some embodiments of the present disclosure.

FIG. 2 through FIG. 5 are flow diagrams illustrating example methods for using a counter for refreshing a transient state of a memory block of a memory device of a memory system, in accordance with some embodiments of the present disclosure.

FIG. 6 is a graph illustrating example data used to determine an adjustment value to a counter based on temperature and time, in accordance with some embodiments of the present disclosure.

FIG. 7 is a block diagram of an example computer system in which embodiments of the present disclosure may operate.

### DETAILED DESCRIPTION

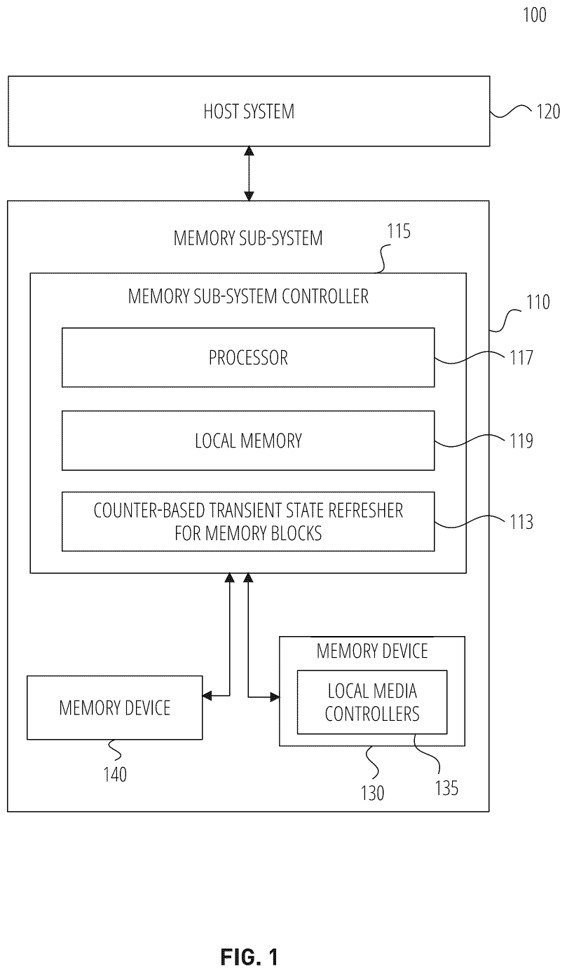

Aspects of the present disclosure are directed to using a counter for refreshing a transient state of a block of a memory device of a memory system, such as a memory sub-system, which can facilitate improved readability of data stored in the memory block. A memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data. The host system can send access requests to the memory sub-system, such as to store data at the memory sub-system and to read data from the memory sub-system.

The host system can send access requests (e.g., write command, read command) to the memory sub-system, such as to store data on a memory device at the memory sub-system, read data from the memory device on the memory sub-system, or write/read constructs (e.g., such as submission and completion queues) with respect to a memory device on the memory sub-system. The data to be read or written, as specified by a host request, is hereinafter referred to as “host data” or “user data.”

A host request can include logical address information (e.g., logical block address (LBA), namespace) for the host data, which is the location the host system associates with the host data and a particular zone in which to store or access the host data. The logical address information (e.g., LBA, namespace) can be part of metadata for the host data. Metadata can also include error handling data (e.g., error-correcting code (ECC) code word, parity code), data version (e.g., used to distinguish age of data written), valid bitmap (which LBAs or logical transfer units contain valid data), and so forth.

The memory sub-system can initiate media management operations, such as a write operation, on host data that is stored on a memory device. For example, firmware of the memory sub-system may re-write previously written host data from a location of a memory device to a new location as part of a garbage collection management operation (or garbage collection process). The data that is re-written, for example as initiated by the firmware, is hereinafter referred to as “garbage collection data.”

“User data” hereinafter generally refers to host data and garbage collection data. “System data” hereinafter refers to data that is created and/or maintained by the memory sub-system for performing operations in response to host requests and for media management. Examples of system data include, and are not limited to, system tables (e.g., logical-to-physical memory address mapping table (also referred to herein as a L2P table), data from logging, scratch pad data, and so forth).

A memory device can be a non-volatile memory device. A non-volatile memory device is a package of one or more die. Each die can be comprised of one or more planes. For some types of non-volatile memory devices (e.g., AND-type devices), each plane is comprised of a set of physical blocks. For some memory devices, blocks are the smallest area that can be erased. Each block is comprised of a set of pages. Each page is comprised of a set of memory cells, which store bits of data. The memory devices can be raw memory devices (e.g., NAND), which are managed externally, for example, by an external controller. The memory devices can be managed memory devices (e.g., managed NAND), which are a raw memory device combined with a local embedded controller for memory management within the same memory device package. The memory device can be divided into one or more zones where each zone is associated with a different set of host data or user data or application.

Certain memory devices, such as NAND-type memory devices, comprise one or more blocks, (e.g., multiple blocks), with each of those blocks comprising multiple memory cells. For instance, a memory device can comprise multiple pages (also referred to as wordlines), with each page comprising a subset of memory cells of the memory device. A threshold voltage (VT) of a memory cell (of a block) can be the voltage at which the floating gate (e.g., NAND transistor), implementing the memory cell, turns on and conducts (e.g., to a bit line coupled to the memory cell). Generally, writing data to such memory devices involves programming (by way of a program operation) the memory devices at the page level of a block, and erasing data from such memory devices involves erasing the memory devices at the block level (e.g., page level erasure of data is not possible).

Three-dimensional (3D) NAND-type memory devices represent an advancement over traditional two-dimensional (2D) NAND-type memory devices with their higher density and efficiency. One of the persistent challenges in 3D NAND-type memory devices is the unstable read behavior exhibited by its memory cells, which primarily arises from an apparent shift in the voltage threshold of the memory cells due to the trapping and annihilation of charges around the memory cells.

During the programming operation of memory cells of a 3D NAND-type memory device (when data is being written to the memory cells), the memory cells enter what is known as a “transient state,” where the internal charge structures of the memory cells are temporarily unstable. In this state, the structures within the memory cells are charged and gradually return to a “stable state” over time. Generally, reading (or retrieving) stored data from memory cells that are in the “transient state” results in fewer read errors than when the memory cells are in a “stable state.” The rate at which these memory cells return to stability is influenced by several factors, which can include leakage currents within the memory cells and the temperature of the 3D NAND-type memory device. These dynamics can directly impact the read error rates observed during read operations performed on the memory cells (to retrieve data stored thereon).

Traditional techniques for mitigating the effects of these shifts and reducing error rates during read operations have included the use of a dummy read operation (or a dummy read). For example, for some traditional techniques, dummy read operations are performed (e.g., executed) on blocks of a memory device (e.g., 3D NAND-type memory device) before actual (non-dummy) read operations are performed on the blocks to retrieve stored data from the blocks. In doing so, the dummy read can bring the memory cells of the blocks back to their transient state right before a real read operation is performed, thereby reduce error rates during the real read operation. This approach (of performing dummy read operation before each real read operation), while somewhat effective, still suffers from some drawbacks, such as increased power consumption and potential impacts on the quality of service (QoS) of the memory device.

Various embodiments described herein cure or address these and other deficiencies of conventional memory technologies. In particular, various embodiments described herein provide for using one or more counters for refreshing (e.g., via a dummy read operation) a transient state of one or more memory blocks of a memory device (e.g., a NAND-type memory device, such as a 3D NAND-type memory device) of a memory system.

As used herein, refreshing a transient state of an individual block comprises performing an operation (e.g., a dummy read operation) on the individual block to cause the individual block to be placed in the transient state or a state closer to the transient state. As used herein, a dummy read operation can comprise applying a read voltage to one or more memory cells of an individual block of a memory device without transferring data to any data latch of the memory device. For various embodiments, the application of the read voltage to a memory cell (e.g., a wordline of memory cells) helps recharge the memory cell and bring it to (or closer to) a transient state, which is favorable for accurate reading of data stored in the memory cell. As used herein, a non-dummy read operation (e.g., actual read operation) can refer to a read operation that involves applying a read voltage at least one memory cell of a block of a memory device and transferring stored data from the at least one memory cell to at least one data latch of the memory device.

According to some embodiments, a memory system maintains counters for blocks of a memory device, and monitors and manages a time interval at which a counter-update-and-check process is performed. For some embodiments, the counter-update-and-check process comprises updating one or more counters corresponding to one or more memory blocks of a memory device based on an adjustment value, and checking if any of the counters satisfy a transient state refresh condition. If an individual counter satisfies the condition, the memory system can cause a dummy read operation to be performed on an individual block of the memory device corresponding to the individual counter, in order to place memory cells of the individual block in a transient state (or in a state closer to the transient state). The process of placing memory cells of a block in a transient state (or a state closer to the transient state) can be referred to herein as a transient state refresh process. For some embodiments, the memory system determines a current temperature associated with the memory device (e.g., via a thermal sensor that measures the current temperature), which can assist in determining (e.g., updating) the time interval at which the counter-update-and-check process will be performed again, in determining (e.g., updating) the adjustment value used to update one or more counters, are both. Various embodiments factor in a current temperature associated with a memory device as part of the transient state refresh process, as the current temperature can affect leakage rates of memory cells and, thus, the stability of those memory cells (e.g., the rate at which a memory cell transitions from a transient state to a stable state). Temperature-based adjustment of counters, time intervals, or both can help various embodiments improve and optimize timing of when memory blocks are refreshed to be placed in a transient state.

For some alternative embodiments, the memory system determines the elapsed time since the counter-update-and-check process was last performed and adjusts counters based on this time, the current temperature associated with the memory device, or both.

For some embodiments, the memory system resets a counter corresponding to an individual block when the individual block is accessed, such as when a non-dummy read operation or a write operation is performed on the individual block. Further, after the memory system exits a suspended state, the memory system can determine the duration the memory system was in suspension and, if sufficiently long, the memory system can reset each counter and cause a dummy read operation to be performed on each block of memory device corresponding to the counters (e.g., being managed for transient state).

Use of various embodiments provide more efficient methods for managing the transient state behavior of memory cells of a memory device (e.g., 3D NAND-type memory device) to enhance overall device reliability and performance without compromising power efficiency and QoS. Specifically, a memory system of various embodiments can ensure that dummy read operations are performed on blocks of a memory device in a more selective manner (e.g., when necessary or assumed to be necessary), thereby reducing the number of dummy read operations performed, which can reduce power consumption and potential QoS degradation within the memory system.

As used herein, a superblock of a memory device (e.g., of a memory system) comprises a plurality (e.g., collection or grouping) of blocks of the memory device. For example, a superblock of a NAND-type memory device can comprise a plurality of blocks that share a same position in each plane in each of one or more NAND-type memory die of the NAND-type memory device.

While various embodiments are described herein with respect to 3D NAND-type memory devices, techniques described herein can (e.g., after adaptation) be used with other types of memory devices, such as 2D NAND-type memory devices. Additionally, while various embodiments are described herein with respect to blocks of a memory device having their transient state refreshed, techniques described herein can (e.g., after adaptation) be performed on superblocks, or some other granularity of the memory device.

Disclosed herein are some examples of using a counter for refreshing a transient state of a block of a memory device of a memory system (e.g., memory sub-system), as described herein.

FIG. 1 illustrates an example computing system 100 that includes a memory sub-system 110, in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, a secure digital (SD) card, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-systems 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

The host system 120 can include a processor chipset and a software stack executed by the processor chipset. The processor chipset can include one or more cores, one or more caches, a memory controller (e.g., NVDIMM controller), and a storage protocol controller (e.g., a peripheral component interconnect express (PCIe) controller, serial advanced technology attachment (SATA) controller). The host system 120 uses the memory sub-system 110, for example, to write data to the memory sub-system 110 and read data from the memory sub-system 110.

The host system 120 can include or be coupled to the memory sub-system 110 so that the host system 120 can read data from or write data to the memory sub-system 110. The host system 120 can be coupled to the memory sub-system 110 via a physical host interface. Examples of a physical host interface include, but are not limited to, a serial advanced technology attachment (SATA) interface, a peripheral component interconnect express (PCIe) interface, a compute express link (CXL) interface, a universal serial bus (USB) interface, a Fibre Channel interface, a Serial Attached SCSI (SAS) interface, etc. The physical host interface can be used to transmit data between the host system 120 and the memory sub-system 110. The host system 120 can further utilize an NVM Express (NVMe) interface to access the memory devices 130, 140 when the memory sub-system 110 is coupled with the host system 120 by the PCIe or CXL interface. The physical host interface can provide an interface for passing control, address, data, and other signals between the memory sub-system 110 and the host system 120.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a NAND type flash memory and write-in-place memory, such as a three-dimensional (3D) cross-point memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional (2D) NAND and 3D NAND.

Each of the memory devices 130, 140 can include one or more arrays of memory cells. One type of memory cell, for example, single-level cells (SLCs), can store one bit per cell. Other types of memory cells, such as multiple-layer cells (MLCs), triple-layer cells (TLCs), quad-level cells (QLCs), and penta-level cells (PLCs), can store multiple bits per cell. In some embodiments, each of the memory devices 130, 140 can include one or more arrays of memory cells such as SLCs, MLCs, TLCs, QLCs, or any combination of such. In some embodiments, a particular memory device can include an SLC portion, and an MLC portion, a TLC portion, or a QLC portion of memory cells. The memory cells of the memory devices 130, 140 can be grouped as pages that can refer to a logical unit of the memory device used to store data. With some types of memory (e.g., NAND), pages can be grouped to form blocks. As used herein, a block comprising SLCs can be referred to as a SLC block, a block comprising MLCs can be referred to as a MLC block, a block comprising TLCs can be referred to as a TLC block, and a block comprising QLCs can be referred to as a QLC block.

Although non-volatile memory components such as NAND type flash memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide-based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide-based RRAM (OxRAM), negative-or (NOR) flash memory, and electrically erasable programmable read-only memory (EEPROM).

A memory sub-system controller 115 (or controller 115 for simplicity) can communicate with the memory devices 130, 140 to perform operations such as reading data, writing data, or erasing data at the memory devices 130, 140 and other such operations. The memory sub-system controller 115 can include hardware such as one or more integrated circuits and/or discrete components, a buffer memory, or a combination thereof. The hardware can include digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, and so forth. The local memory 119 can also include ROM for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device 130 and/or the memory device 140. The memory sub-system controller 115 can be responsible for other operations such as wear leveling operations, garbage collection operations, error detection and ECC operations, encryption operations, caching operations, and address translations between a logical address (e.g., LB A, namespace) and a physical memory address (e.g., physical block address) that are associated with the memory devices 130, 140. The memory sub-system controller 115 can further include host interface circuitry to communicate with the host system 120 via the physical host interface. The host interface circuitry can convert the commands received from the host system 120 into command instructions to access the memory device 130 and/or the memory device 140 as well as convert responses associated with the memory device 130 and/or the memory device 140 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130, 140.

In some embodiments, the memory device 130 includes local media controllers 135 that operate in conjunction with memory sub-system controller 115 to execute operations on one or more memory cells of the memory device 130. An external controller (e.g., memory sub-system controller 115) can externally manage the memory device 130 (e.g., perform media management operations on the memory device 130). In some embodiments, a memory device 130 is a managed memory device, which is a raw memory device combined with a local controller (e.g., local media controller 135) for media management within the same memory device package. An example of a managed memory device is a managed NAND (MNAND) device.

The memory sub-system controller 115 includes a counter-based transient state refresher for memory blocks 113 (hereafter, the counter-based transient state refresher 113) that enables or facilitates the memory sub-system controller 115 to use one or more counters for refreshing a transient state of one or more memory blocks of the memory device 130 or 140 of the memory sub-system 110 in accordance with various embodiments described herein. Alternatively, some or all of the counter-based transient state refresher 113 is included by the local media controller 135, thereby enabling the local media controller 135 to enable or facilitate use of one or more counters to refresh a transient state of one or more memory blocks of the memory device 130 in accordance with various embodiments described herein.

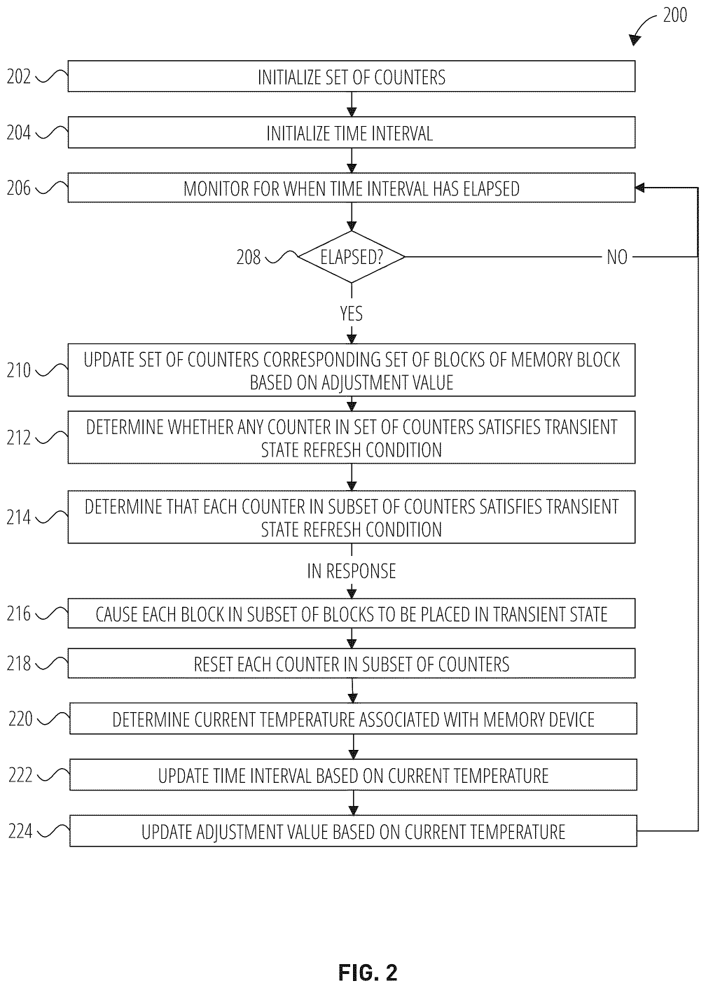

FIG. 2 through FIG. 5 are flow diagrams illustrating example methods 200, 300, 400, 500 for using a counter for refreshing a transient state of a block of a memory device of a memory system, in accordance with some embodiments of the present disclosure. Any of methods 200, 300, 400, 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, any of methods 200, 300, 400, 500 is performed by the memory sub-system controller 115 of FIG. 1 based on the counter-based transient state refresher 113. Additionally, or alternatively, for some embodiments, any of methods 200, 300, 400, 500 is performed, at least in part, by the local media controller 135 of the memory device 130 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are used in every embodiment. Other process flows are possible.

Referring now to the method 200 of FIG. 2, at operation 202, a processing device (e.g., the processor 117 of the memory sub-system controller 115) initializes a set of counters based on an initial counter value. For some embodiments, the set of counters corresponds to a set of blocks of a memory device (e.g., 130) of a memory system (e.g., memory sub-system 110). As an example, where an individual counter is intended to be decremented (e.g., by a value of 1) each time a counter-update-and-check process is performed, the initial counter value can be set to a positive number, such as 100. As another example, where an individual counter is intended to be incremented (e.g., by a value of 1) each time a counter-update-and-check process is performed, the initial counter value can be set to zero. Additionally, for some embodiments, a memory system (e.g., memory sub-system 110) initializes and maintains the set of counters in local memory (e.g., local memory 119) of the memory system. Depending on the embodiment, the current value of a counter can be adjusted upward (e.g., incremented in value) or downward (e.g., decremented in value) during a counter-update-and-check process. At operation 204, the processing device initializes a time interval based on an initial time value. For some embodiments, the time interval value determines when a counter-update-and-check process is performed. For various embodiments, performing the counter-update-and-check process comprises performing one or more of operations 210 through operation 222.

Thereafter, at operation 206, the processing device monitors for when the time interval has elapsed. For some embodiments, the processing device uses a timer of the memory system (e.g., memory sub-system 110) to determine when the time interval has passed. The timer can be, for instance, a countdown timer that is set to the time interval and then started. When the countdown timer expires, a signal can be generated or an interrupt can occur, which can indicate the time interval has elapsed. For some embodiments, timestamps are used to determine when the time interval has elapsed. For instance, an initial timestamp can be recorded, the counter-update-and-check process can periodically be performed, and the counter-update-and-check process can determine based on a current timestamp check whether the time interval has elapsed.

At decision block 208, in response to the processing device determining that time interval has elapsed, the method 200 proceeds to operation 210, otherwise the method 200 returns to operation 206, where the processing device continues to monitor for when the time interval has elapsed.

At operation 210, the processing device updates (e.g., adjusts) the set of counters corresponding to the set of blocks based on an adjustment value. For example, the adjustment value can be applied to the respective current value of each counter in the set of counters. Depending on the embodiment, the adjustment value can cause the respective values of counters (in the set of counters) to be incremented or decremented in value. The adjustment value can be a static value, or a dynamic value that can be updated (e.g., redetermined) during performance of the counter-update-and-check process (e.g., operation 224). According to various embodiments, a value of a counter corresponding to a block (of the memory device) can indicate whether the block is ready for a transient state refresh (e.g., via a dummy read operation).

For operation 212, the processing device determines (e.g., checks) whether any counter in the set of counters satisfies a transient state refresh condition. For some embodiments, the transient state refresh condition comprises a condition based on a threshold counter value. For instance, the transient state refresh condition can be defined to be satisfied by an individual counter if the value of the counter is equal to or surpasses (e.g., is greater than or is less than, depending on the embodiment) the threshold counter value. As an example, where an individual counter is intended to be decremented (e.g., by a value of 1) each time a counter-update-and-check process is performed and the initial counter value is set to a positive number (e.g., 100), the threshold value can be set to zero. As another example, where an individual counter is intended to be incremented (e.g., by a value of 1) each time a counter-update-and-check process is performed and the initial counter value is set to zero, the threshold value can be set to a positive number, such as 100. The transient state refresh condition can also be referred to as a counter expiration condition, where an individual counter satisfying the transient state refresh condition can be considered an expired counter.

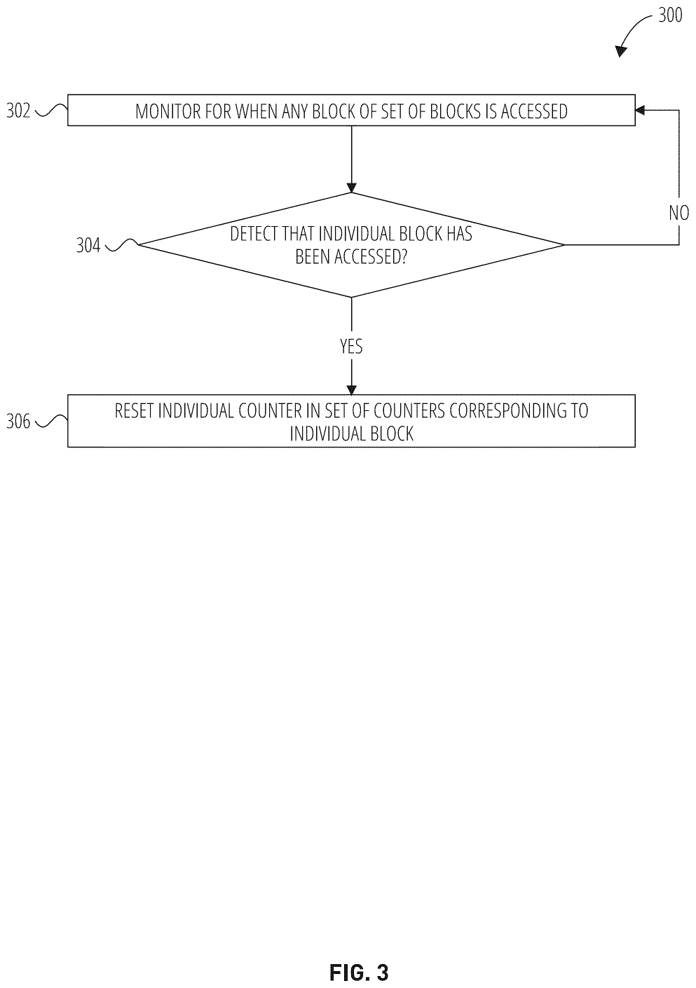

While FIG. 2 illustrates operation 212 after operation 210 is performed, it should be noted that for some embodiments, operation 212 is performed prior to operation 210 being performed. Additionally, though each counter starts with an initial value, it should be noted that the value of different counters can differ as method 200 is performed, as one or more counters can be reset (e.g., to an initial counter value or a reset counter value) as a result of one or more corresponding counters being accessed by an actual (non-dummy) read operation or a write operation. More regarding the resetting of counters is illustrated and described with respect to the method 300 of FIG. 3.

At operation 214, the processing device determines that each counter in a subset of counters (of the set of counters) satisfies the transient state refresh condition. In response, at operation 216, the processing device causes each block in a subset of blocks (of the set of blocks) to be placed in a transient state (or in a state close to the transient state), where the subset of blocks corresponds to the subset of counters (determined at operation 214). Further, in response to determining that each counter in the subset of counters satisfies the transient state refresh condition, at operation 218, the processing device resets each counter in the subset of counters (e.g., to an initial value or to a reset counter value that is different from the initial value). Based on resetting an individual counter (in the subset of counters), the counter-update-and-check process will next refresh the transient state of an individual block corresponding to the individual counter when the individual counter next satisfies the transient state refresh condition. Depending on the embodiment, the reset counter value can be the same as the initial counter value used during operation 202.

How the processing device causes (at operation 216) the transient state of an individual block to be placed in the transient state (or in a state close to the transient state) can differ between different embodiments. For example, operation 216 can comprise the processing device performing (e.g., immediately performing) a dummy read operation on an individual block in the subset of blocks. Alternatively, in another example, operation 216 can comprise the processing device flagging an individual block (e.g., flagging each individual block) in the subset of blocks such that a dummy read operation is performed on the individual block prior to a non-dummy read operation being performed on any portion of the individual block. The flagging of the individual block can comprise setting a flag in metadata associated with the individual block, or flagging of the individual block in separate data (e.g., table maintained by the memory sub-system controller 115). According to various embodiments, a dummy read operation places the individual block in the transient state by applying a read voltage to a set of memory cells of the individual block without causing the transfer of data to any data latch of the memory device. The data latches can comprise, for example, page buffers of the memory device used during a write operation or an actual read operation performed on the memory device.

At operation 220, the processing device determines a current temperature associated with the memory device. For example, the memory system can comprise a thermal sensor (e.g., temperature sensor) configured to measure the current temperature associated with the memory device, and the processing device can directly or indirectly obtain the current temperature from the thermal sensor. Depending on the embodiment, the current temperature can comprise at least one of: the temperature of the memory device (e.g., a thermal sensor disposed on a physical surface of the memory device); the temperature of an internal environment of the memory system (e.g., a thermal sensor measures temperature inside housing or casing of the memory system); the temperature of an external environment of the memory system (e.g., a thermal sensor measures temperature outside the housing or casing of the memory system); or a temperature provided by a host system (e.g., 120) operatively coupled to the memory system.

As part of the counter-update-and-check process, the memory system can update at least one of the next time interval or the next adjustment (counter) value to be used (with respect to the counter-update-and-check process) based on the current temperature determined at operation 220. Depending on the embodiment, either operation 222, operation 224, or both is performed after operation 220 and, thereafter, the method 200 returns to operation 206, where the processing device monitors for when operation 210 will be performed again (e.g., for when the counter-update-check process will be performed again). At operation 222, the processing device can update the (current) time interval based on the current temperature, where an updated time interval will determine when operation 210 will be performed again (e.g., when the counter-update-check process). At operation 224, the processing device can update the adjustment value based on the current temperature, where an updated adjustment value will be used to update the set of counters by the processing device at operation 210. Depending on the embodiment, operation 222 can comprise the processing device using predetermined data (e.g., stored in a table on the memory system) or a function (e.g., defined by data stored on the memory system) to generate a new/updated time interval based on the current temperature. Likewise, operation 224 can comprise the processing device using predetermined data (e.g., stored in a table on the memory system) or a function (e.g., defined by data stored on the memory system) to generate a new/updated adjustment value based on the current temperature.

Referring now to FIG. 3, the method 300 illustrates an example process for updating one or more counters in a set of counters (corresponding to a set of blocks of a memory device) in response to one or more block access operations performed outside of the counter-update-and-check process. For some embodiments, the method 300 represents a process that is performed in parallel or nearly in parallel with the method 200 of FIG. 2 (e.g., methods 200 and 300 are performed by the processing device as separate threads).

At operation 302, a processing device (e.g., the processor 117 of the memory sub-system controller 115) monitors for when any block of the set of blocks is accessed (e.g., by the processing device). For example, during operation 302, the processing device can monitor for when at least one of a non-dummy read operation or a write operation is performed on any block of the set of blocks. According to various embodiments, performing a non-dummy read operation or a write operation on an individual block can result in the individual block being placed in a transient state (or at least in a state closer to the transient state).

At decision block 304, in response to the processing device detecting that an individual block of the set of blocks has been accessed (e.g., a non-dummy read operation or a write operation has been performed on the individual block), the method 300 proceeds to operation 306, where the processing device resets an individual counter in the set of counters that corresponds to the individual block. Depending on the embodiment, the individual counter can be reset to an initial counter value or a reset counter value that is different from the initial counter value. Alternatively, at decision block 304, in response to the processing device not detecting access of any block of the set of blocks, the method 300 returns to operation 302, where the processing device continues to monitor for when any block of the set of blocks is accessed.

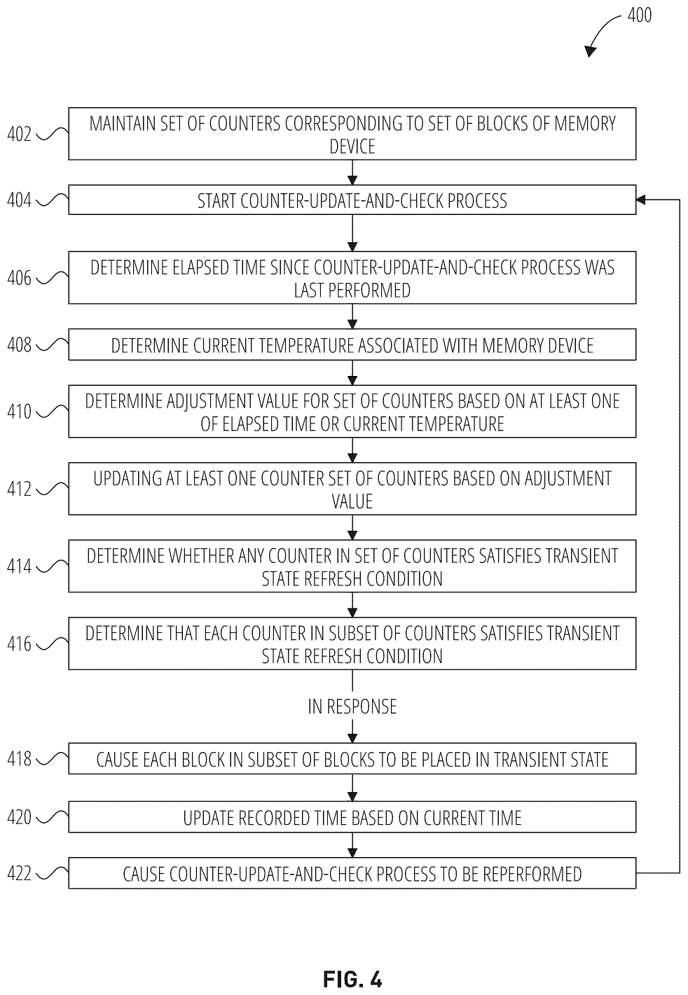

Referring now to FIG. 4, the method 400 represents an alternative method for using a counter for refreshing a transient state of a block of a memory device of a memory system. At operation 402, a processing device (e.g., the processor 117 of the memory sub-system controller 115) maintains a set of counters corresponding to a set of blocks of a memory device. Eventually, at operation 404, the processing device starts a counter-update-and-check process. For some embodiments, performing the counter-update-and-check process comprises performing one or more of operations 406 through 420.

At operation 406, the processing device determines an elapsed time since the counter-update-and-check process was last performed. For various embodiments, operation 406 comprises the processing device accessing a recorded time (e.g., recorded timestamp) that indicates the last time the counter-update-and-check process, and comparing (e.g., determining a time difference between) the recorded time and a current time (e.g., current timestamp), which can be provided by a clock of the memory system.

Thereafter, at operation 408, the processing device determines a current temperature associated with the memory device. For example, the memory system can comprise a thermal sensor (e.g., temperature sensor) configured to measure the current temperature associated with the memory device, and the processing device can directly or indirectly obtain the current temperature from the thermal sensor. Depending on the embodiment, the current temperature can comprise at least one of: the temperature of the memory device (e.g., a thermal sensor disposed on a physical surface of the memory device); the temperature of an internal environment of the memory system (e.g., a thermal sensor measures temperature inside housing or casing of the memory system); the temperature of an external environment of the memory system (e.g., a thermal sensor measures temperature outside the housing or casing of the memory system); or a temperature provided by a host system (e.g., 120) operatively coupled to the memory system.

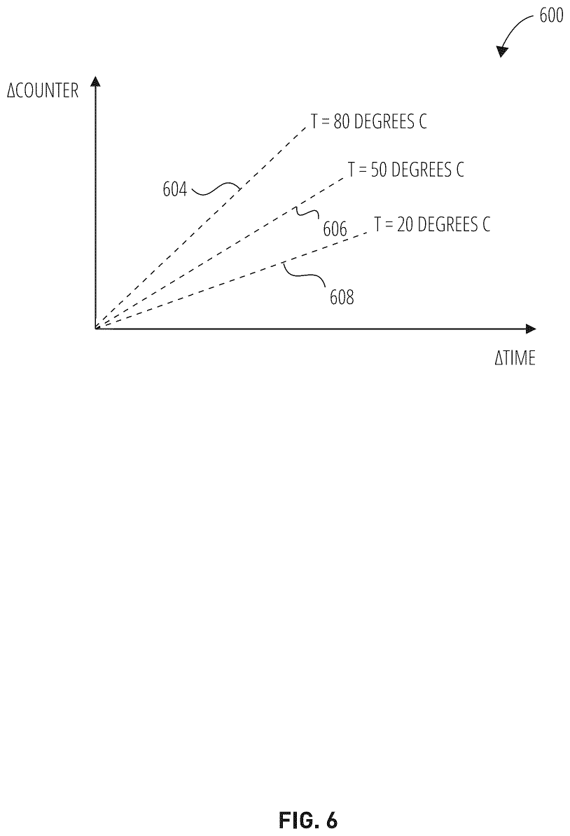

Subsequently, at operation 410, the processing device determines (e.g., generates or updates) an adjustment value for the set of counters based on at least one of the elapsed time (determined at operation 406) or the current temperature associated with the memory device (determined at operation 408). For some embodiments, operation 410 comprises the processing device using predetermined data (e.g., stored in a table on the memory system) or a function (e.g., defined by data stored on the memory system) to generate the adjustment value based on the elapsed time, the current temperature, or both. An example of data that can be used by the processing device is illustrated and described with respect to FIG. 6.

Then, at operation 412, the processing device updates at least one counter (e.g., each counter) in the set of counters based on the adjustment value determined at operation 410. For example, the adjustment value can be applied to the respective current value of each counter in the set of counters. Depending on the embodiment, the adjustment value can cause the respective values of counters (in the set of counters) to be incremented or decremented in value.

After operation 412, operation 414, operation 416, and operation 418 are performed. For various embodiments, operations 414, 416, 418 are respectively similar to operations 212, 214, 216 described with respect to the method 200 of FIG. 2.

Subsequently, at operation 420, the processing device updates the recorded time (indicating the last time the counter-update-and-check process was performed) based on a current time. For various embodiments, the elapsed time is determined (at operation 406) based on the recorded time, and operation 420 enables operation 406 to be performed.

For some embodiments, operation 420 can represent the end of the counter-update-and-check process. Eventually, at operation 422, the processing device causes the counter-update-and-check process to be reperformed. This is represented in FIG. 4 by the method 400 returning to operation 404 after operation 422. Depending on the embodiment, the processing device can cause the counter-update-and-check process to be performed periodically or in response to a trigger condition being satisfied (e.g., after any access operation is performed on the memory system).

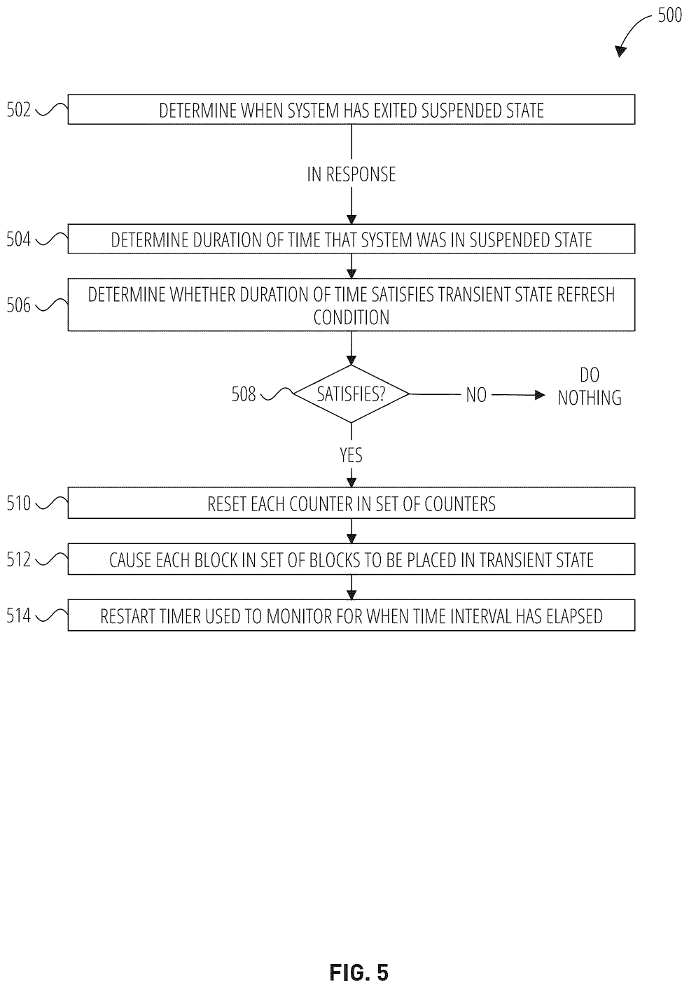

Referring now to FIG. 5, the method 500 represents a method for updating one or more counters in a set of counters (corresponding to a set of blocks of a memory device) in response to a memory system exiting a suspended state (e.g., and entering/resuming an active or full operational state). At operation 502, a processing device (e.g., the processor 117 of the memory sub-system controller 115) determines when a memory system (e.g., memory sub-system 110) has exited a suspended state. Depending on the embodiment, a power management component of the memory system can inform various components of the memory system when the memory system exits a suspended state and resumes non-suspended operation (e.g., full operation).

In response to determining that the memory system has exited the suspended state, at operation 504, the processing device determines a duration of time that the memory system was in the suspended state. For instance, the processing device can access a recorded time (e.g., recorded timestamp) that was updated at or right before the memory system entered the suspended state, and compare (e.g., determine a time difference between) the recorded time and a current time (e.g., current timestamp) provided by the memory system. Then, at operation 506, the processing device determines whether the duration of time satisfies a (second) transient state refresh condition. This transient state refresh condition can comprise a condition based on a threshold time value. For instance, the transient state refresh condition can be satisfied if the duration of time (determined at operation 504) surpasses (e.g., is greater than) the threshold time value. For various embodiments, the longer the memory system remains in a suspended state, the more likely each block in the set of blocks needs a transient state refresh.

At decision block 508, in response to determining that the transient state refresh condition is satisfied, the method 500 proceeds to operation 510, otherwise the method 500 does nothing (e.g., the duration of the suspended state does not warrant a transient state refresh be performed). At operation 510, the processing device resets each counter in the set of counters (e.g., to an initial value or to a reset counter value that is different from the initial value). Additionally, at operation 512, the processing device causes each block in the set of blocks to be placed in the transient state. For some embodiments, operation 512 comprises the processing device performing (e.g., immediately performing) a dummy read operation on each block in the set of blocks. Alternatively, for some embodiments, operation 512 comprises the processing device flagging each individual block in the set of blocks such that a dummy read operation is performed on the individual block prior to a non-dummy read operation being performed on any portion of the individual block.

Depending on the embodiment, at operation 514, the processing device restarts a timer that is used by the processing device to determine (e.g., monitor) when to next perform a counter-update-and-check process as described herein.

FIG. 6 is a graph 600 illustrating example data used to determine an adjustment value to a counter based on temperature and time, in accordance with some embodiments of the present disclosure. In particular, the graph 600 shows how based on an elapsed time (e.g., since the last time counters were updated and checked) represented by ΔTIME and a current temperature T associated with a memory device (e.g., 130) of a memory system (e.g., memory sub-system 110), an adjustment value (represented by ΔCOUNTER) can be determined. In particular, the graph 600 illustrates a relationship between ΔTIME and ΔCOUNTER for when the current temperature T is 80 degrees Celsius (plot 604), 50 degrees Celsius (plot 606), and 20 degrees Celsius (plot 608). Though the graph 600 illustrates linear relationships between ΔTIME, ΔCOUNTER, and the current temperature T, for various embodiments, the relationship can be non-linear. Depending on the embodiment, the data used to determine the adjustment value (to a counter) can be stored in a table format or generated by a function (e.g., ΔCOUNTER (ΔTIME, T)).

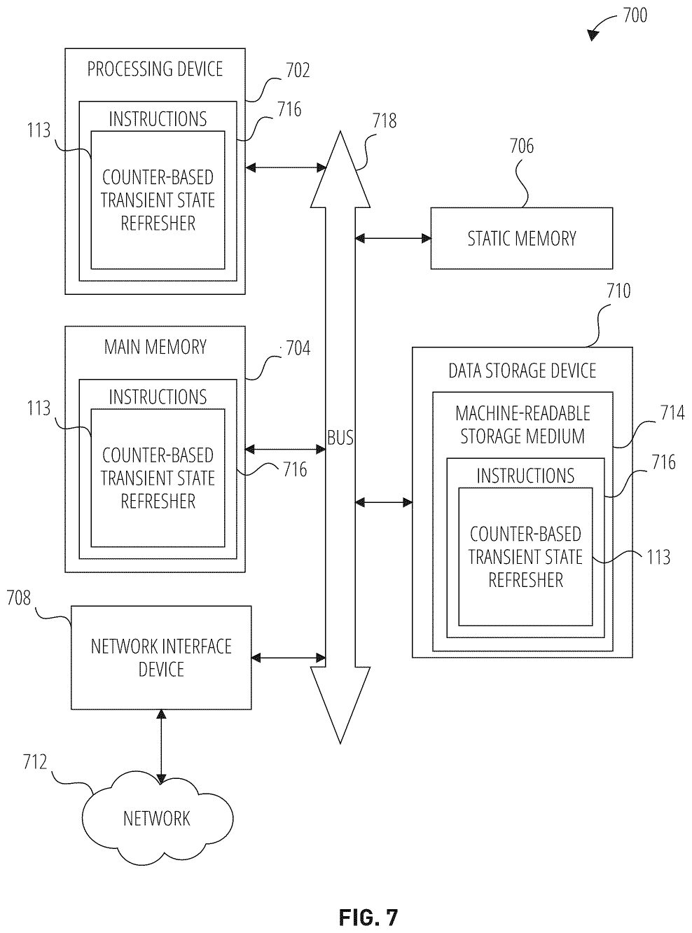

FIG. 7 illustrates an example machine in the form of a computer system 700 within which a set of instructions can be executed for causing the machine to perform any one or more of the methodologies discussed herein. In some embodiments, the computer system 700 can correspond to a host system (e.g., the host system 120 of FIG. 1) that includes, is coupled to, or utilizes a memory sub-system (e.g., the memory sub-system 110 of FIG. 1) or can be used to perform the operations described herein. In alternative embodiments, the machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., ROM, flash memory, DRAM such as SDRAM or Rambus DRAM (RDRAM), etc.), a static memory 706 (e.g., flash memory, static random access memory (SRAM), etc.), and a data storage device 710, which communicate with each other via a bus 718.

The processing device 702 represents one or more general-purpose processing devices such as a microprocessor, a central processing unit, or the like. More particularly, the processing device 702 can be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 702 can also be one or more special-purpose processing devices such as an application-specific integrated circuit (ASIC), a field programmable gate array (FPGA), a digital signal processor (DSP), a network processor, or the like. The processing device 702 is configured to execute instructions 716 for performing the operations and steps discussed herein. The computer system 700 can further include a network interface device 708 to communicate over a network 712.

The data storage device 710 can include a machine-readable storage medium 714 (also known as a computer-readable medium) on which is stored one or more sets of instructions 716 or software embodying any one or more of the methodologies or functions described herein. The instructions 716 can also reside, completely or at least partially, within the main memory 704 and/or within the processing device 702 during execution thereof by the computer system 700, the main memory 704 and the processing device 702 also constituting machine-readable storage media. The machine-readable storage medium 714, data storage device 710, and/or main memory 704 can correspond to the memory sub-system 110 of FIG. 1.

In one embodiment, the instructions 716 include instructions to implement functionality corresponding to use a counter for refreshing a transient state of a block of a memory device of a memory system as described herein (e.g., the counter-based transient state refresher 113 of FIG. 1). While the machine-readable storage medium 714 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Described implementations of the subject matter can include one or more features, alone or in combination as illustrated below by way of examples.

Example 1 is a system comprising: a memory device comprising a set of blocks; and a processing device, operatively coupled to the memory device, configured to perform operations comprising: monitoring for when a time interval has elapsed; and in response to the time interval elapsing, performing a counter-update-and-check process that comprises: updating a set of counters corresponding to the set of blocks based on an adjustment value; determining that each counter in a subset of counters of the set of counters satisfies the transient state refresh condition, the subset of counters corresponding to a subset of blocks of the set of blocks; and in response to determining that each counter in the subset of counters satisfies the transient state refresh condition, causing each block in the subset of blocks to be placed in a transient state.

In Example 2, the subject matter of Example 1 includes, wherein the transient state refresh condition comprises a condition based on a threshold counter value.

In Example 3, the subject matter of Examples 1-2 includes, wherein the operations comprise: in response to determining that each counter in the subset of counters satisfies the transient state refresh condition, resetting each counter in the subset of counters to a reset counter value.

In Example 4, the subject matter of Examples 1-3 includes, wherein the operations comprise: monitoring for when either a non-dummy read operation or a write operation is performed on any block of the set of blocks; and in response to detecting that either the non-dummy read operation or the write operation has been performed on an individual block of the set of blocks, resetting an individual counter in the set of counters corresponding to the individual block to a reset counter value.

In Example 5, the subject matter of Examples 1˜4 includes, wherein the operations comprise: in response to the time interval elapsing: determining a current temperature associated with the memory device; and based on the current temperature, updating the time interval for when the counter-update-and-check process is next performed.

In Example 6, the subject matter of Example 5 includes, wherein the operations comprise: after the updating of the time interval, reperforming the counter-update-and-check process based on the time interval as updated.

In Example 7, the subject matter of Examples 5-6 includes, a thermal sensor configured to measure the current temperature associated with the memory device.

In Example 8, the subject matter of Examples 1-7 includes, wherein the operations comprise: in response to the time interval elapsing: determining a current temperature associated with the memory device; and updating the adjustment value based on the current temperature.

In Example 9, the subject matter of Example 8 includes, a thermal sensor configured to measure the current temperature associated with the memory device.

In Example 10, the subject matter of Examples 1-9 includes, wherein the causing of each block in the subset of blocks to be placed in the transient state comprises: flagging an individual block in the subset of blocks such that a dummy read operation is performed on the individual block prior to a non-dummy read operation being performed on any portion of the individual block, the dummy read operation placing the individual block in the transient state by applying a read voltage to a set of memory cells of the individual block without causing transfer of data to any data latch of the memory device.

In Example 11, the subject matter of Examples 1-10 includes, wherein the causing of each block in the subset of blocks to be placed in the transient state comprises: performing a dummy read operation on an individual block in the subset of blocks, the dummy read operation placing the individual block in the transient state by applying a read voltage to a set of memory cells of the individual block without causing transfer of data to any data latch of the memory device.

In Example 12, the subject matter of Examples 1-11 includes, wherein the operations comprise: initializing the set of counters based on an initial counter value; and initializing the time interval based on an initial time value.

In Example 13, the subject matter of Examples 1-12 includes, wherein the transient state refresh condition is a first transient state refresh condition, and wherein the operations comprise: determining when the system has exited a suspended state; and in response to determining that the system has exited the suspended state: determining a duration of time that the system was in the suspended state; determining whether the duration of time satisfies a second transient state refresh condition; and in response to the duration of time satisfying the second transient state refresh condition: resetting each counter in the set of counters to a reset counter value; and causing each block in the set of blocks to be placed in the transient state.

In Example 14, the subject matter of Example 13 includes, wherein the operations comprise: in response to the duration of time satisfying the second transient state refresh condition, restarting a timer used to monitor for when the time interval has elapsed.

Example 15 is a method to implement any of Examples 1-14.

Example 16 is at least one machine-readable medium comprising instructions that, when executed by a processing device, cause the processing device to perform operations to implement any of Examples 1-14.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks, ROMs, RAMS, EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a ROM, RAM, magnetic disk storage media, optical storage media, flash memory components, and so forth. A machine-readable storage medium can be non-transitory (in other words, not having any transitory signals) in that it does not embody a propagating signal. However, labeling a machine-readable storage medium “non-transitory” should not be construed to mean that the machine-readable storage medium is incapable of movement; the machine-readable storage medium should be considered as being transportable from one physical location to another.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

1. A system comprising:
a memory device comprising a set of blocks; and
a processing device, operatively coupled to the memory device, configured to perform operations comprising:
monitoring for when a time interval has elapsed; and
in response to the time interval elapsing, performing a counter-update-and-check process that comprises:
updating a set of counters corresponding to the set of blocks based on an adjustment value;
determining that each counter in a subset of counters of the set of counters satisfies the transient state refresh condition, the subset of counters corresponding to a subset of blocks of the set of blocks; and
in response to determining that each counter in the subset of counters satisfies the transient state refresh condition, causing each block in the subset of blocks to be placed in a transient state.

2. The system of claim 1, wherein the transient state refresh condition comprises a condition based on a threshold counter value.

3. The system of claim 1, wherein the operations comprise:
in response to determining that each counter in the subset of counters satisfies the transient state refresh condition, resetting each counter in the subset of counters to a reset counter value.

4. The system of claim 1, wherein the operations comprise:
monitoring for when either a non-dummy read operation or a write operation is performed on any block of the set of blocks; and
in response to detecting that either the non-dummy read operation or the write operation has been performed on an individual block of the set of blocks, resetting an individual counter in the set of counters corresponding to the individual block to a reset counter value.

5. The system of claim 1, wherein the operations comprise:
in response to the time interval elapsing:
determining a current temperature associated with the memory device; and
based on the current temperature, updating the time interval for when the counter-update-and-check process is next performed.

6. The system of claim 5, wherein the operations comprise:
after the updating of the time interval, reperforming the counter-update-and-check process based on the time interval as updated.

7. The system of claim 5, comprising:
a thermal sensor configured to measure the current temperature associated with the memory device.

8. The system of claim 1, wherein the operations comprise:
in response to the time interval elapsing:
determining a current temperature associated with the memory device; and
updating the adjustment value based on the current temperature.

9. The system of claim 8, comprising:
a thermal sensor configured to measure the current temperature associated with the memory device.

10. The system of claim 1, wherein the causing of each block in the subset of blocks to be placed in the transient state comprises:
flagging an individual block in the subset of blocks such that a dummy read operation is performed on the individual block prior to a non-dummy read operation being performed on any portion of the individual block, the dummy read operation placing the individual block in the transient state by applying a read voltage to a set of memory cells of the individual block without causing transfer of data to any data latch of the memory device.

11. The system of claim 1, wherein the causing of each block in the subset of blocks to be placed in the transient state comprises:
performing a dummy read operation on an individual block in the subset of blocks, the dummy read operation placing the individual block in the transient state by applying a read voltage to a set of memory cells of the individual block without causing transfer of data to any data latch of the memory device.

12. The system of claim 1, wherein the operations comprise:
initializing the set of counters based on an initial counter value; and
initializing the time interval based on an initial time value.

13. The system of claim 1, wherein the transient state refresh condition is a first transient state refresh condition, and wherein the operations comprise:
determining when the system has exited a suspended state; and
in response to determining that the system has exited the suspended state:
determining a duration of time that the system was in the suspended state;
determining whether the duration of time satisfies a second transient state refresh condition; and
in response to the duration of time satisfying the second transient state refresh condition:
resetting each counter in the set of counters to a reset counter value; and
causing each block in the set of blocks to be placed in the transient state.

14. The system of claim 13, wherein the operations comprise:
in response to the duration of time satisfying the second transient state refresh condition, restarting a timer used to monitor for when the time interval has elapsed.

15. At least one non-transitory machine-readable storage medium comprising instructions that, when executed by a processing device, cause the processing device to perform operations comprising:
maintaining a set of counters corresponding to a set of blocks of a memory device; and
performing a counter-update-and-check process that comprises:
determining an elapsed time since the counter-update-and-check process was last performed;
determining an adjustment value for the set of counters based on at least one of the elapsed time or a current temperature associated with the memory device;
updating at least one counter in the set of counters based on the adjustment value;
determining that each counter in a subset of counters of the set of counters satisfies the transient state refresh condition, the subset of counters corresponding to a subset of blocks of the set of blocks; and
in response to determining that each counter in the subset of counters satisfies the transient state refresh condition, causing each block in the subset of blocks to be placed in a transient state.

16. The non-transitory machine-readable storage medium of claim 15, wherein the operations comprise:
determining the current temperature associated with the memory device.

17. The non-transitory machine-readable storage medium of claim 15, wherein the elapsed time is determined based on a recorded time of last performance of the counter-update-and-check process, and wherein the counter-update-and-check process comprises:
updating the recorded time based on a current time.

18. The non-transitory machine-readable storage medium of claim 15, wherein the counter-update-and-check process is performed periodically.

19. The non-transitory machine-readable storage medium of claim 15, wherein the counter-update-and-check process is based on a trigger condition.

20. A method comprising:
maintaining, by a processing device, a set of counters corresponding to a set of blocks of a memory device; and
performing, by the processing device, a counter-update-and-check process that comprises:
determining an elapsed time since the counter-update-and-check process was last performed;
determining an adjustment value for the set of counters based on at least one of the elapsed time or a current temperature associated with the memory device;
updating at least one counter in the set of counters based on the adjustment value;
determining that each counter in a subset of counters of the set of counters satisfies the transient state refresh condition, the subset of counters corresponding to a subset of blocks of the set of blocks; and
in response to determining that each counter in the subset of counters satisfies the transient state refresh condition, causing each block in the subset of blocks to be placed in a transient state.
